(19) United States
(12) Patent Application Publication
(10) Pub. No.: US 2016/0169574 A1
(43) Pub. Date: Jun. 16, 2016

(54) AN APPARATUS AND SYSTEM FOR THE GENERATION OF POTABLE WATER FROM THE ATMOSPHERE

(71) Applicant: MERLIN INVESTMENT MANAGEMENT PTY LTD., Bundall, Queensland (AU)

(72) Inventor: Vladimir Jakovina, Benowa, Queensland (AU)

(21) Appl. No.: 14/903,661

(22) PCT Filed: Jul. 9, 2014
(86) PCT No.: PCT/AU2014/000701

§ 371 Date: Jan. 8, 2016

(30) Foreign Application Priority Data
Jul. 10, 2013 (AU) 2013902541

(51) Int. Cl. F25D 21/14; F25B 13/00; F25D 17/04; B01D 5/00

(52) U.S. Cl. CPC F25D 21/14; B01D 5/0081; B01D 5/009; B01D 5/0003; F25B 13/00; F25D 17/04

(57) ABSTRACT

An apparatus and system for the generation of potable water from air. The apparatus includes a ventilation fan for moving air into and through the apparatus; a gas compressor for compressing and cooling a refrigerant gas; at least one venturi radiator fin for receiving the compressed gas and cooling surrounding air; and a reservoir for collecting potable water condensed from the cooled air. The system may include several of the apparatus.

### FIELD OF THE INVENTION

The present invention relates to an apparatus and system for the generation of potable water.

### BACKGROUND

The availability of potable water has been identified as one of the largest problems facing mankind into the future. As the human population grows and the effects of long term climate change occur, it is foreseen that potable water will become increasingly scarce.

It is predicted that climate change will cause rainfall patterns to change, causing rain to fall in different areas than it has historically. As such, large centres of population, such as cities, may find that their water supply is affected. This phenomenon has been experienced in the South West corner of Western Australia over the previous two decades, wherein the average rainfall received in the period is significantly less than the historical average.

In response to the declining levels of rainfall, governments have begun to create infrastructure to either recycle water or to create potable water from non-potable supplies. Accordingly, there has been a large increase in the number of desalination plants currently being constructed, wherein sea water is desalinated to make potable water.

Desalination and water recycling plants are expensive to build, though, and face significant operating expenses, particularly as most desalination plants operate using a reverse osmosis system. These systems are known to require significant amounts of electricity to operate.

Recycled water plants commonly take water from sewage treatment plants, which has been treated to remove biological matter from the water. The water, after initial treatment, is often further treated using the same reverse osmosis as a desalination plant to subsequently remove additional impurities from the treated water. As such, water from recycled water plants is also expensive in terms of the amount of energy involved in removing biological matter and further purifying the water.

Recycled water is also often viewed negatively by consumers due to the stigma attached to drinking water from a sewage process.

The present invention attempts to overcome at least in part the aforementioned disadvantages of previous systems for generating potable water.

### SUMMARY OF THE INVENTION

In accordance with one aspect of the present invention, there is provided an apparatus for the generation of potable water characterised in that it comprises:

a ventilation fan for moving air into and through the apparatus;

a gas compressor for compressing and cooling a refrigerant gas;

at least one venturi radiator in for receiving the compressed gas and cooling surrounding air; and

a reservoir for collecting potable water condensed from the cooled air.

Condensate from the cooled air may form on the at least one venturi radiator fin in water droplets until they reach sufficient size to fall from the fin to be collected in the reservoir.

The apparatus may further comprise a heat exchanger which is in fluid communication with the compressor, for receiving fluid heated by the operation of the compressor and heating the air.

The air heated by the heat exchanger may be at a substantially similar temperature to the air moved into the apparatus by the ventilation fan, before it is cooled.

The apparatus may further comprise an inlet air filter for reducing or eliminating particulate matter from entering the apparatus or reservoir.

The apparatus may further comprising an outlet air filter for reducing or eliminating particulate matter from exiting the apparatus.

The air moved by the ventilation fan may be substantially laminar as it passes the at least one venturi radiator fin.

The apparatus may further comprise a means for connection to any type of electrical energy for powering the apparatus.

In accordance with a second aspect of the present invention, there is provided a system for the generation of potable water comprising a plurality of apparatus, each apparatus characterised by:

a ventilation fan for moving air into and through the apparatus;

a gas compressor for compressing and cooling a refrigerant gas;

at least one venturi radiator fin for receiving the compressed gas and cooling surrounding air; and

a reservoir for collecting potable water condensed from the cooled air.

The system may be mounted within a rotatable housing for orientating the system in accordance with atmospheric conditions.

The system according to claim 10, characterised in that it may be orientated toward prevailing wind fur additional air flow through the plurality of apparatus.

The system may comprise a means for generating electricity for powering the plurality of apparatus.

The means for generating electricity may comprise a heat motor.

The means for generating electricity may comprise one or more solar panels.

The system ay comprise a reservoir for capturing water generated by the system.

The system may comprise control electronics for controlling the operation of the apparatus in accordance with the present invention.

### BRIEF DESCRIPTION OF DRAWINGS

The present invention will now be described, by way of example, with reference to the accompanying drawings, in which:

FIG. 1 is a side view of an apparatus for generating potable water in accordance with the present invention.

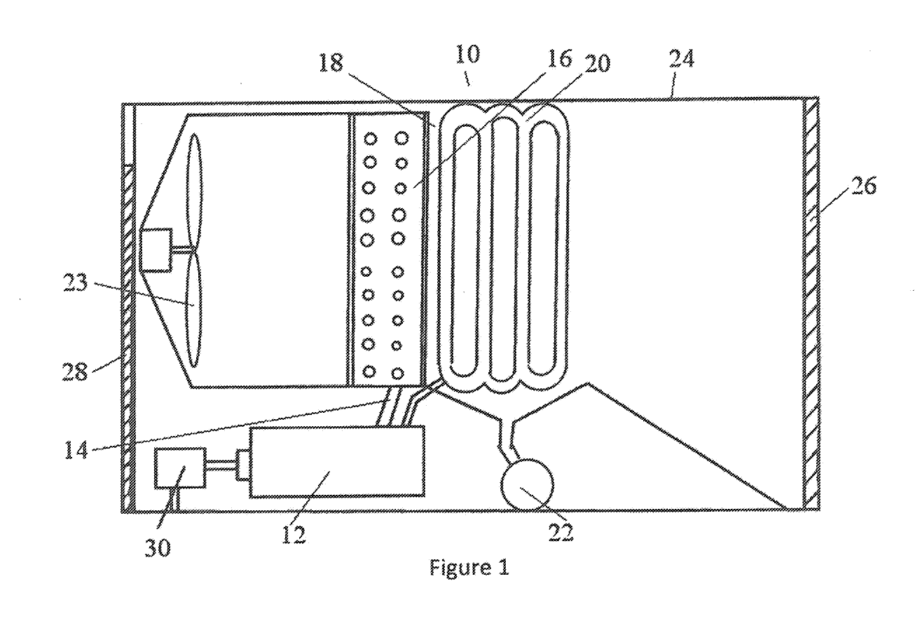

FIG. 2 is a front view of a system for generating potable water in accordance with the present invention.

### DESCRIPTION OF PREFERRED EMBODIMENT

Referring to the Figures, there is shown an apparatus 10 for the generation of potable water. The apparatus 10 comprises a compressor 12 for compressing a refrigerant gas, a heat exchanger 16 comprising a radiator 18 and a plurality of venturi radiator fins 20 and a reservoir 22 for the collection of potable water. The compressor 12 is in fluid communication 14 with the heat exchanger 16.

The apparatus 10 further comprises a ventilation fan 23 for controlling the flow of air into and out of the frame 24 of the apparatus 10. Additionally, inlet filter 26 and outlet filter 28 may be fitted to the frame 24 to ensure particulate matter does not enter the apparatus 10 or the reservoir 22. The apparatus 10 may further comprise an energy source 30 of any suitable known type.

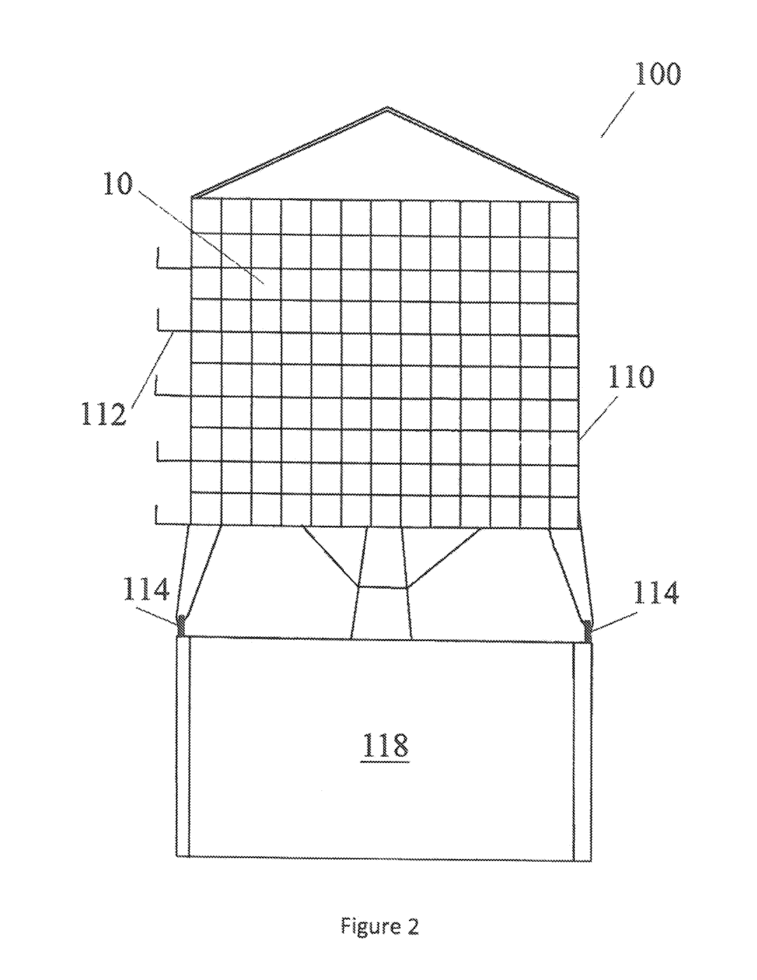

FIG. 2 shows a system 100 in accordance with the present invention. The system 100 comprises a plurality of apparatus 10 arranged within a structure 110. As necessary, the structure 110 may include ladders, gantries and access ways 112 to allow maintenance of the plurality of apparatus 10.

In accordance with a preferred embodiment of the present invention the structure 110 is mounted on a plurality of rollers 114. The structure 110 is further connected to a means of providing rotational torque such as an electrical motor to provide locomotion for the structure 110.

The structure 100 is preferably mounted over a reservoir 118 for capturing and storing water, with each of the plurality of apparatus 10 housed within the structure 110 being in fluid communication with the reservoir 118 such that any water generated by the apparatus 10 may freely flow to the reservoir 118.

In accordance with another preferred embodiment of the present invention, the system 100 further comprises control electronics (not shown). The control electronics may be housed in a separate location to the structure 110 or inside the structure 110 depending upon operational requirements.

Preferably, the system 100 further comprises a means (not shown) for generating electrical energy for its own consumption. The means 122 for generating electrical energy may take the form of any device or groups of devices capable of delivering sufficient electrical energy for the system 100 to operate.

In use, the apparatus 10 is connected to a source of electrical energy 30. The source of electrical energy maybe a regular mains power supply or, in accordance with a preferred embodiment of the present invention, a solar energy system. The apparatus 10 draws electrical energy from the source 30 to power the compressor 12. The compressor 12 acts to compress a refrigerant gas as commonly known in the field of refrigeration or air conditioners.

The gas compressor 12 compresses the refrigerant gas causing the refrigerant gas to cool in a manner which would be easily understood to a skilled person. The compressed refrigerant gas is forced under pressure into the venturi fins 20. The refrigerant gas acts to cool the venturi fins 20.

The ventilation fan 23 is started and draws air from outside in through the inlet air filter 26. Air is drawn from the atmosphere surrounding the apparatus 10 through and past the venturi fins 20.

As the venturi fins 20 have been chilled by the refrigerant gas passing through them, as the air passes the venturi fins 20, the air itself is cooled. As will be apparent, the cooling of the air causes water vapour from the atmosphere to condense. The condensation forms water droplets which would collect on the venturi fins 20 until such time as they obtain a sufficient size and therein fall down the venturi fins 20 to be collected in the reservoir 22.

As the compressor 12 is run, it generates heat through its normal operation. The heat exchanger 16 takes heated fluid, through the fluid communication means 14, from the compressor 12. As the air cooled through its passage by the chilled venturi fins 20 passes through the heat exchanger 16, the air is heated again. Finally, the heated air then passes the ventilation fan 23 and is forced through the outlet air filter 28.

In accordance with a preferred embodiment of the present invention, the air passing through the outlet filter 28 is at substantially the same temperature as the air drawn through the inlet filter 26. This provides the advantage that it is possible to regulate the temperature of the compressor 12 such that it operates at its maximum efficiency level in terms of temperature.

In accordance with another preferred embodiment of the present invention, the ventilation fan 23 is arranged to be separated from the venturi fins 20 sufficiently such that the flow of air generated by the ventilation fan 23 is substantially laminar as it passes the venturi fins 20.

In accordance with another aspect of the present invention, the operation of the system 100 will now be described with reference to the accompanying drawings. The system 100 comprises a plurality of apparatus 10 in accordance with the present invention. The arrangement of the apparatus 10 can be made to any size and shape and is housed within a structure 110.

The operation of the system 100 is controlled by known control electronics in a manner which would be understood by a skilled person. The control electronics control all aspects of operation, from those of the apparatus 10 that are operating; to controlling the orientation of the structure 110.

Preferably the structure 110 is arranged such that the inlet side of the plurality of apparatus 10 are directed toward the prevailing wind direction in accordance with atmospheric conditions. It has been found that, in this way, additional air flow through the apparatus 10 is achieved, leading to improved water generation.

The structure 110 is mounted on a number of rollers 114 which are arranged to allow the structure 110 to be rotated about a point The structure 100 is in communication with a means of providing a rotational torque such as an electric motor, for providing the necessary forces to rotate the structure 110. It should be apparent that this process need not be completed in response to small shifts in the wind direction but in response to major wind directions changes.

The system 100 also comprises a means for generating electrical energy, or may be connected directly to a base load power grid. The energy generation means provides electrical power for the operation of the plurality of apparatus 10 and to the means for providing rotational torque.

Each of the plurality of apparatus 10 are controlled by the control electronics, such that they operate at their ideal efficiency, both in terms of climatic conditions and also in controlling usage to ensure that each of the apparatus 10 operate for approximately the same amount of time.

As will be apparent, the ladders, gantries and access ways 112 are provided to allow workers to perform maintenance on the plurality of apparatus 10. The control electronics are able to continue operation of the system while maintenance is being performed.

Modifications and variations as would be apparent to a skilled addressee are deemed to be within the scope of the present invention.

What is claimed is:

1. An apparatus for the generation of potable water characterised in that it comprises:
a ventilation fan for moving air into and through the apparatus;
a gas compressor for compressing and cooling a refrigerant gas;
at least one venturi radiator fin for receiving the compressed gas and cooling surrounding air;
a heat exchanger adjacent the at least one venturi radiator fin; and
a reservoir for collecting potable water condensed from the cooled air,
wherein the ventilation fan is spaced apart from the adjacent heat exchanger and at least one venturi radiator fin.

2. An apparatus according to claim 1, characterised in that condensate from the cooled air forms on the at least one venturi radiator fin in water droplets until they reach sufficient size to fall from the fin to be collected in the reservoir.

3. An apparatus according to claim 1, further comprising a heat exchanger which is in fluid communication with the compressor, for receiving fluid heated by the operation of the compressor and heating the air.

4. An apparatus according to claim 3, characterised in that the air heated by the heat exchanger is at a substantially similar temperature to the air moved into the apparatus by the ventilation fan, before it is cooled.

5. An apparatus according to claim 1, further comprising an inlet air filter for reducing or eliminating particulate matter from entering the apparatus or reservoir.

6. An apparatus according to claim 1, further comprising an outlet air filter for reducing or eliminating particulate matter from exiting the apparatus.

7. An apparatus according to claim 1, characterised in that the air moved by the ventilation fan is substantially laminar as it passes the at least one venture radiator fin.

8. An apparatus according to claim 1, further comprising a means for connection to any type of electrical energy for powering the apparatus.

9. A system for the generation of potable water comprising a plurality of apparatus, each apparatus characterised by:
a ventilation fan for moving air into and through the apparatus;
a gas compressor for compressing and cooling a refrigerant gas;
at least one venturi radiator fin for receiving the compressed gas and cooling surrounding air;
a heat exchanger adjacent the at least one venturi radiator fin; and
a reservoir for collecting potable water condensed from the cooled air,
wherein the ventilation fan is spaced apart from the adjacent heat exchanger and at least one venturi radiator fin.

10. A system according to claim 9, characterised in that it is mounted within a rotatable housing for orientating the system in accordance with atmospheric conditions.

11. A system according to claim 10, characterised in that it is orientated toward prevailing wind for additional air flow through the plurality of apparatus.

12. A system according to claim 9, comprising a means for generating electricity for its own consumption.

13. A system according to claim 13, wherein the means for generating electricity comprises a heat motor.

14. A system according to claim 12, wherein the means for generating electricity comprises one or more solar panels.

15. A system according to claim 6, comprising a reservoir for capturing water generated by the system.

16. A system according to claim 9, comprising control electronics for controlling the operation of the apparatus in accordance with the present invention.
